(19) United States
(12) Patent Application Publication
(10) Pub. No.: US 2005/0286090 A1
(43) Pub. Date: Dec. 29, 2005

(54) Fax review/preview function for an all-in-one multifunction peripheral with a color graphics display and method of using same

(76) Inventors: Adam J. Ahne, Lexington, KY (US); Mark J. Edwards, Lexington, KY (US); Brian K. Owens, Lexington, KY (US); Ricky E. Robbins, Danville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/877,270

(22) Filed: Jun. 25, 2004

(51) Int. Cl. H04N 1/387

(52) U.S. Cl. 358/452

(57) ABSTRACT

A multi-function peripheral comprising a facsimile portion, a memory portion for retaining received fax image data, a graphics display affixed to the multi-function peripheral and in electrical communication with said memory portion, said graphics display depicting the fax image data of the memory portion and including a user interface for zooming and editing the fax image data in the memory portion.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTINGS, ETC.

None.

### BACKGROUND

1. Field of the Invention

The present invention comprises a facsimile (“fax”) review/preview function for a multi-function peripheral with a color or monochrome graphics display. More specifically, the present invention provides a fax review/preview function on a color or monochrome graphics liquid crystal display and allows page-by-page editing of incoming faxes.

2. Description of the Related Art

Businesses and home offices rely upon facsimile (“fax”) devices as an integral part of information transfer which drives business on a daily basis. Fax machines are typically connected to telephone lines in order to send and receive data representation of documents so that those in receipt of the data can print and view the documents being sent to them. Fax machines have developed over the years to include a plurality of features. Although very simple at first, many fax machines now include address books, redial, speed dial, memory for storing documents when the paper input tray is empty and for re-sending a fax when the fax cannot be sent on the first attempt.

However, as technological advances are continually developed for fax devices, additional problems are created. Fax machines receive all data that is sent to them without recognizing data which is sent from solicitors and advertisers. This, in combination with ever increasing dependency on fax machines in home and office, has led to continuous bombardment of “junk” faxes containing various unsolicited advertisements. Advertisers, solicitors, and others take advantage of prior art fax machines which only receive data sent for mass advertising of products which user's generally have little or no interest.

In operation prior art fax machines receive data from fax machines in alternate locations, process the received data, and print the data as a hard copy for viewing by a user or other person intended for receipt of the fax document. Since advertisers and other solicitors take advantage of prior art fax machines by flooding them with advertising for various products, fax users are forced to periodically wade through the printed fax documents and remove advertisements from the personal and business sensitive documents. Alternatively, when a fax machine utilizes all of its paper in the supply tray, the fax machine begins storing received data in memory causing two problems. First, the limited memory is often occupied by advertising faxes until the advertisement is printed. Second, the advertisements must be printed which wastes paper costing the fax owner more money. Still, the end result is the same in that the fax users are forced to print and filter through the printed fax documents in order to separate the advertisements from the business or personal documents.

Some fax machine functions are included on multi-function peripherals which include limited fax capability but require interface with a personal computer (PC) so that a connection with a phone line or internet is available for sending and receipt of fax documents. When used in combination with a personal computer, a user may receive fax documents in a fax ‘inbox’ and be able to delete them, for instance if the fax is a junk fax containing advertising. However, none of the known multi-function peripherals have had editing and deleting ability independent of a personal computer.

### SUMMARY OF THE INVENTION

Given the foregoing deficiencies, it will be appreciated that a multi-function peripheral is needed including stand-alone fax capability allowing users to edit or delete received fax documents utilizing a color or monochrome graphics display.

It is an object of the present invention to provide an all-in-one peripheral having a fax device, a scanner device, and a printer device.

It is a further object of the present invention to provide an all-in-one peripheral having a color or monochrome graphics display.

It is still a further object of the present invention to provide an all-in-one peripheral having a memory for storage of received fax data and scanned data, or fax image data.

It is yet an even further object of the present invention to provide visual access of images stored in the memory utilizing the color or monochrome graphics display.

It is an even further object of the present invention to provide editing and zooming capability of the data stored in the memory.

More specifically a multi-function peripheral comprises a facsimile portion, a memory portion for retaining received facsimiles and storing scanned data, a color or monochrome graphics display affixed to the multi-function peripheral and in electrical communication with said memory portion, said graphics display depicting the received facsimiles and the scanned data of the memory portion and including a user interface for zooming and editing the received facsimiles and scanned data on the memory portion.

### BRIEF DESCRIPTION OF THE DRAWINGS

FIG. 1 is a perspective view of a multifunction peripheral device with fax preview/review of the present invention;

FIG. 2 is a perspective view of the multifunction peripheral device of FIG. 1, with a cut-away portion revealing portions of the image recording apparatus;

FIG. 3 is a plan view of a control panel and color graphics display of the multifunction peripheral device of FIG. 1;

FIG. 4 is a schematic view of the multi-function peripheral device with fax preview/review of FIG. 1;

FIG. 5 is an illustrative menu tree of the present invention for accessing fax data in memory;

FIG. 6 is a function block diagram displaying an alternative method for accessing the fax memory of the multi-function peripheral device;

FIG. 7 is a chart describing the functions of various buttons on the control panel of FIG. 2 when the multi-function peripheral device is used in fax mode;

FIG. 8 is a chart depicting the various available selections in the fax options menu;

FIG. 9 is a view of the scrollable fax menu as seen on the color graphics display of the control panel of FIG. 3;

FIG. 10 is a view of a fax mode default screen as seen on the color graphics display of the control panel of FIG. 3;

FIG. 11 is a selection screen displayed when the preview button is pressed at the fax mode default screen of FIG. 10;

FIG. 12 is a fax preview screen shown on the color graphics display for selecting a fax for printing;

FIG. 13 is a fax preview screen shown on the color graphics display after selecting a specific fax for printing;

FIG. 14 is a fax preview screen shown on the color graphics display of the control panel for selecting a fax for saving to a PC;

FIG. 15 is a fax preview screen shown on a color graphics display of the control panel after selecting a specific fax for saving to a PC;

FIG. 16 is a fax preview screen shown on the color graphics display of the control panel prior to selecting a fax for deletion;

FIG. 17 is a fax preview screen shown on the color graphics display of the control panel after selecting a specific fax for deletion;

FIG. 18 is a fax preview screen shown on the color graphics display of the control panel prior to selecting a fax for forwarding to another fax machine;

FIG. 19 is a fax preview screen shown on the color graphics display of the control panel after selecting a specific fax for forwarding to another fax machine; and,

FIG. 20 is a fax forwarding screen shown on the color graphics display of the control panel instructing a user to input a destination fax phone number.

### DETAILED DESCRIPTION

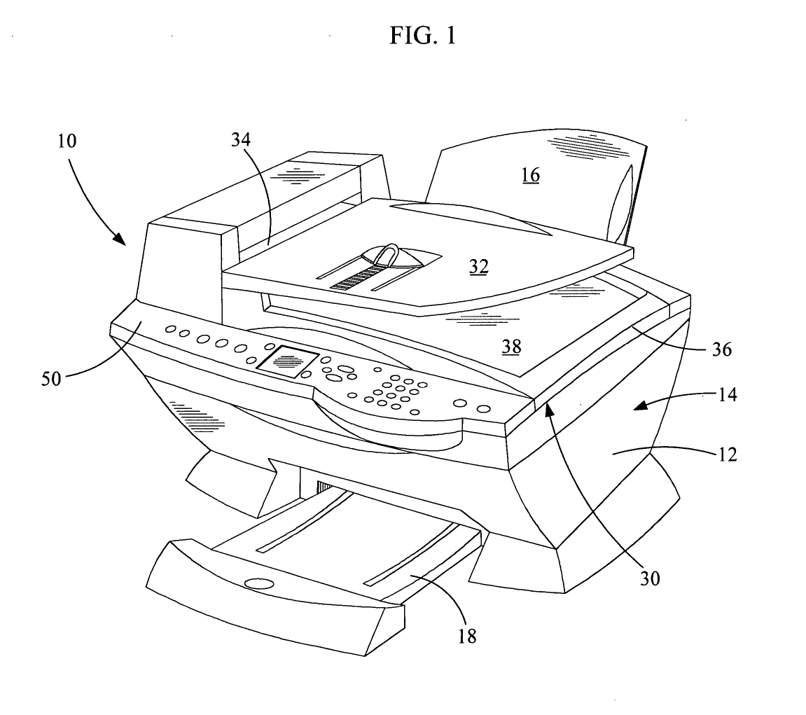

Referring now in detail to the drawings, wherein like numerals indicate like elements throughout the several views, there are shown in FIGS. 1-20 various aspects of a fax preview/review function for a multi-function peripheral with color or monochrome graphics display. The multi-function peripheral device includes a control panel having a color or monochrome graphics display allowing zooming and editing of fax image data, comprising fax data and scanned data, prior to printing of the fax image data so that the data may be reviewed or previewed and edited utilizing a plurality of menus displayed on the color or monochrome graphics display of the control panel.

For purposes of this invention description the term all-in-one and multi-function peripheral device both include an image recording apparatus such as ink jet or laser printer, a fax device, which may be used in stand-alone mode without connection to a host PC or in combination mode with a host PC, and a scanning device. In addition, the term editing can include deletion of one or more user selected pages of a received fax or fax stored in memory. A scanning axis is defined as a path that a scanbar travels during flat bed scanning function. Finally, for purpose of clarity the term color graphics display is used throughout the following description and comprises one illustrative embodiment. However, it should be understood to be well within the scope of the present invention that the display may alternatively be monochrome.

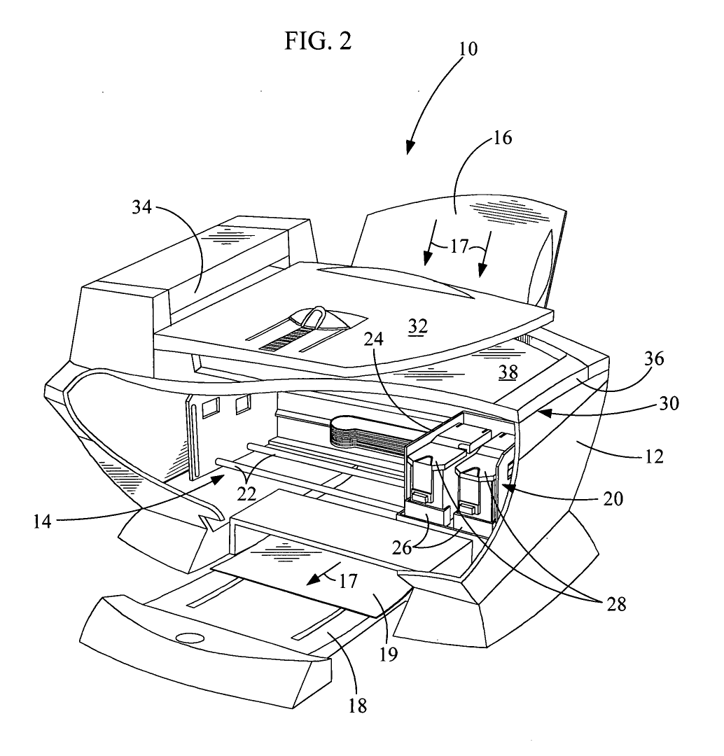

Referring initially to FIGS. 1 and 2, a perspective view of the multi-function peripheral device 10 is shown. The multi-function peripheral 10 includes a housing 12 having an image recording device 20 within the housing 12. The image recording device or printing component 20 of the multifunction peripheral device 10 generally includes a media supply or input tray 16, a media exit or output tray 18, and a media feed path represented by arrows 17 defined between the media supply tray 16 and the media exit tray 18 and through which the media 19 is indexed. Inside the housing 12 of the image recording device 20 is a print cartridge 28 slidably positioned normal to the media feed path 17 and defining a print zone where the feed path 17 intersects movement of the image recording device 20. Extending across the print zone is at least one carrier guide shaft 22 having a carrier 24 slidably positioned thereon such that the carrier 24 travels along a horizontal path substantially perpendicular to the media feed path 17 and so that the paper from the media supply tray 16 is indexed directly beneath the carrier 24. Electrical signals are provided by a print controller to a carrier drive, which are not shown for purpose of clarity, causing the carrier 24 to reciprocate along the at least one carrier guide shaft 22 transverse to the feed path 17.

Positioned within the carrier 24 is at least one receiving station 26 for the ink cartridge 28. Preferably there are at least two ink cartridges 28, a single color ink container and a tri-color ink container. For example, the tri-color ink container may contain cyan, magenta, and yellow inks and the single color ink container may contain black ink. Alternatively however, two or more single color ink cartridges may be utilized or two or more tri-color ink cartridges may be utilized depending on the needs of the user. The at least one ink cartridge 28 is in fluid communication with a printhead, not shown, for ejecting ink to the print media traveling along the paper or media feed path. More specifically, electrical signals are also provided to the printhead by a flexible cable or ribbon cable providing signals to the carrier and printhead to selectively activate the printhead and nozzles therein to eject ink onto the print media traveling there below. While an exemplary thermal inkjet system is shown and described herein, it is well within the scope of the present invention that a piezo inkjet or laser printer may be substituted for the image recording device 20 taught herein.

Still referring to FIG. 1 and 2, the printing component 20 further comprises a paper advance mechanism, not shown, comprising for instance a motor, a drive, and at least one roller for indexing the print media 19 through a print zone where the media feed path meets the carrier path defined by the carrier guide shafts 22. The paper advance mechanism includes the media supply tray 16 located in the present embodiment at the rear of the image recording apparatus 10 and the media exit tray 18. The media supply tray 16 extends downwardly into the housing 12 defining a beginning to the media feed path. As shown in FIG. 1, the media supply tray 16 is positioned at an angle which is substantially upright and almost vertical while the media exit tray 18 is substantially horizontal and extending from the front of the housing 12. Such a configuration is called an L-path because the media is indexed through a substantially L-shaped path. However, alternative feed path configurations may be utilized such as a C-path wherein the media supply tray is substantially horizontal and positioned either above or below the media exit tray. According to the C-path configuration, the media is indexed through a substantially C-shaped path.

Positioned on an upper portion of the housing 12 is a scanner bed 30 utilized for scanning documents, figures, and photos for subsequent printing or copying, saving to a host PC, a removable memory or storage device or a network, or faxing to another fax machine. According to a first method of use the scanner bed 30 may be used to scan documents drawings, or photos which are not readily handled by an automatic document feeder 34. A top cover 36 is preferably pivotally attached to the scanner bed 30 along a rear edge of the scanner bed housing so that, if a user desires to scan a photo or small size document which may not feed through the automatic document feeder 34, the top cover 36 may be opened revealing a scanning platen. The small document or photo may be positioned on the platen and scanned utilizing the scanning components within the scanner bed 30 such as a scanbar.

According to the illustrative embodiment of FIG. 1 an automatic document feeder input tray 32 is positioned above the scanner bed 30 for retaining a plurality of documents for scanning by the scanner bed 30. The original documents are positioned on the upper surface of the automatic document feed input tray 32 and indexed through an adjacent automatic document feeder 34. The automatic document feeder 34 is primarily used for scanning text based documents, figures, or photos on standard full size pages, such as 8½″×11″, which are readily handled by the automatic document feeder 34.

Within the automatic document feeder 34 are a plurality of components which are not shown but generally described including a plurality of rollers and at least one motor which may index or advance an original document for scanning there through. More specifically, text based documents positioned in the automatic document feeder input tray 32 are pulled from the input tray 32 through the automatic document feeder 34 and past an automatic document feeder glass (not shown) exposing text or figures on the original document to a scanbar beneath the automatic document feeder 34 including a light source, an image sensor and a mirror for obtaining a scanned image from the original document. The original document indexes forward and exits the automatic document feeder 34 at the automatic document feeder exit tray 38 for retrieval by a user.

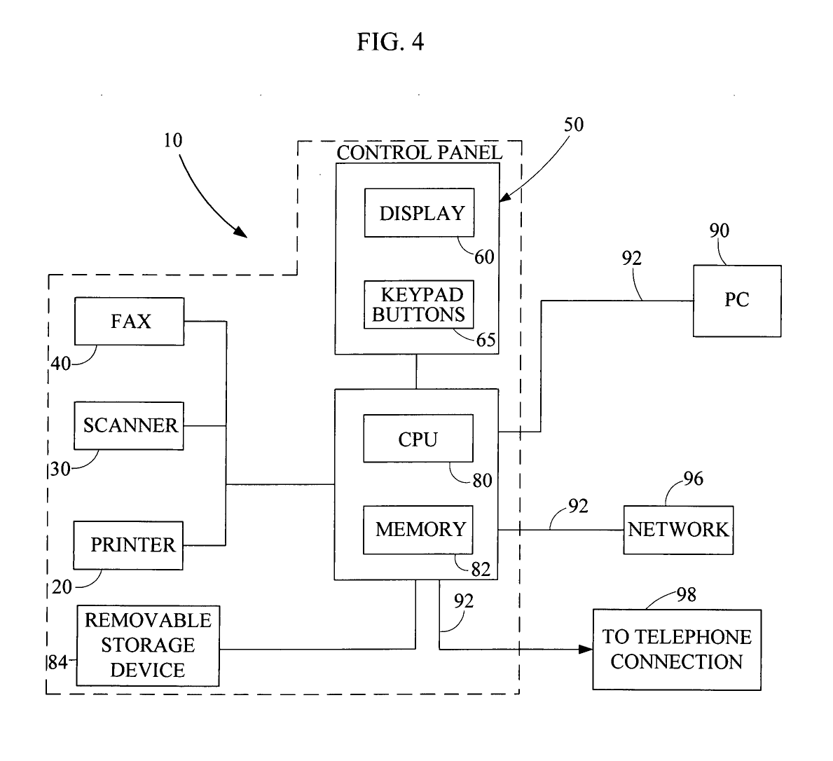

The previously mentioned scanbar which is not shown but generally described includes an image sensor which may be a contact image sensor (CIS) or a charge coupled device (CCD). The CIS utilizes at least one LED and preferably a plurality of LEDs to provide a light source requiring no warm-up time. In other words, the CIS is an instant-on device. Alternatively, the CCD utilizes a lamp requiring a specific warm-up time and therefore does incur a delay prior to scanning from a cold start. In either event the scanbar is positioned beneath the automatic document feeder glass and exposes the original document passing there above to a light source. For a CCD device, mirrors and lenses located within the scanbar direct the image reflected from the original document to the image sensor within the scanbar. As shown in FIG. 4, the image sensor then determines the image and sends the data representing the image to onboard memory 82, a removable storage device 84, or a PC 90 or network server 96 housing a hard disk or an optical disk drive such as a CD-R, CD-RW, or DVD-R/RW via a cable connection 92 or via a wireless connection utilizing, for example, an 802.11x standard or “Bluetooth” wireless connectivity. As is known in the art, a similar process occurs with the CIS-type of image sensor. Alternatively, the original document may be scanned by the optical scanning component and a copy printed from the image recording apparatus 20 such as with the multi-function peripheral device 10.

Alternatively, the flat-bed scanning mode may be utilized wherein an original document, photo or figure may be positioned on the scanning platen located beneath the top cover 36. According to this embodiment the scanbar located within the scanner bed 30 and may be positioned on at least one guide bar disposed within the scanner bed 30 and extending in a direction of a scanning axis to guide the scanbar through the scanning axis beneath the scanning platen. As previously described the scanbar illuminates the original document placed on the platen utilizing either a lamp in the case of a CCD device or at least one LED in the case of a CIS device. Again, in either event, optics located within the scanbar direct the image reflected from the original document to the image sensor and the image is sent to onboard memory 82, a removable storage device 84, or a PC 90 or network server 96 housing a hard disk drive or an optical disk drive such as a CD-R, CD-RW, or DVD-R/RW. And alternatively, the original document may be scanned and a copy printed from the printer or image recording apparatus 20.

In operation of the scanner 30, a light source is turned on and a sensor determines whether original documents or media are positioned in the automatic document feeder input tray 32. If the sensor determines that documents are located in the input tray 32 then the sensor elements in the scanbar calibrate on a white background located on a bottom of the scanner bed housing 30. Next the scanbar is positioned under the automatic document feeder glass and the original documents are indexed or advanced through the automatic document feeder 34 to begin scanning. If however the sensor determines that no media is positioned in the automatic document feeder input tray 32 the scanbar calibrates the image sensors on the white background located on a bottom surface of the scanner bed housing 30. Next the scanbar ramps-up in velocity until a constant velocity is reached and the scanbar begins taking scanned data at a first flatbed scan position or scan origin. This scan origin position is typically located on the scanner platen by an origin mark such as an arrow in a corner or along a side of the scan bed 30 adjacent the platen prompting a user for placement of an original. It should be understood that various scanning mechanisms may be utilized that the forgoing description is merely illustrative of one such scanning mechanism.

Referring now to FIG. 4, the multi-function peripheral device 10 further comprises a facsimile (fax) device 40 which is utilized to send and receive data via a telephone line or over broadband internet connections. The fax device 40 generally comprises the control panel 50, the scanner 30, printer 20, and a data connection to send and receive data by, for example, a telephone connection 98.

Referring now to FIGS. 1, 3 and 4 a control panel 50 is shown positioned along a front edge of the housing 12 and adjacent the scanner bed 30. The control panel 50 includes a plurality of keys or buttons allowing a user to operate the multi-function peripheral device 10. The control panel 50 includes a power button 51, a stop/clear button 52, a copy function button 53, a scan function button 54, and a fax function button 55. Associated with the copy function is a number of copies button 56 allowing a user to select the number of copies desired. Associated with the fax function 40 is an alpha-numeric keypad 66, a speed dial button 70 and a redial/pause button 67. Also associated with the copy, scan and fax functions are buttons 68, 69 allowing a user to select between color or monochrome scanning, copying or faxing. Also located on the control panel 50 is a color graphics display 60. The color graphics display may be a liquid crystal display (LCD) and may be utilized to view and edit data stored within the onboard temporary memory 82 of the multi-function peripheral device 10. The control panel further includes a preview button 57 for viewing of various data stored in the onboard memory 82, an options button 58 for providing the user with various options available by menus on the color graphics display 60, a delete button 59 for editing or deletion of unwanted pages which are stored in the onboard memory 82, a select button 61 for selecting a desired option which may be shown on the menus viewable with the color graphics display 60 and a plurality of cursor buttons 62, 63, 64, 65 for scrolling through the menus and data seen on the color graphics display 60. The control panel 50 also includes a zoom button 71 allowing zooming of a fax stored in the onboard memory and being viewed in the color graphics display 60.

Referring to FIG. 4, a schematic view of the multi-function peripheral device 10 of the present invention is shown. The device 10 comprises a printer 20, a scanner 30, and a fax 40 in electronic communication with a CPU 80 and memory 82 onboard the multi-function peripheral device 10. The temporary onboard memory 82 may be solid state random access memory or nonvolatile random access memory. The CPU 80 and memory 82 are in electronic communication with the control panel 50 including the display 60 and keypad buttons, for example 65. A PC 90 may be connected to the multi-function peripheral device 10 via a cable connection 92 such as a USB cable or a parallel cable connection between the multi-function peripheral device 10 and PC 90. Alternatively, the multifunction peripheral 10 may be in communication with a PC 90 via wireless connection as previously described. The multi-function peripheral device 10 may also comprise a telephone jack 98 for connection of a telephone line to the device 10 for use in stand alone fax operation. Finally, the multi-function peripheral device 10 may further comprise a removable storage memory device slot 84 for storage of scanned data or received faxes.

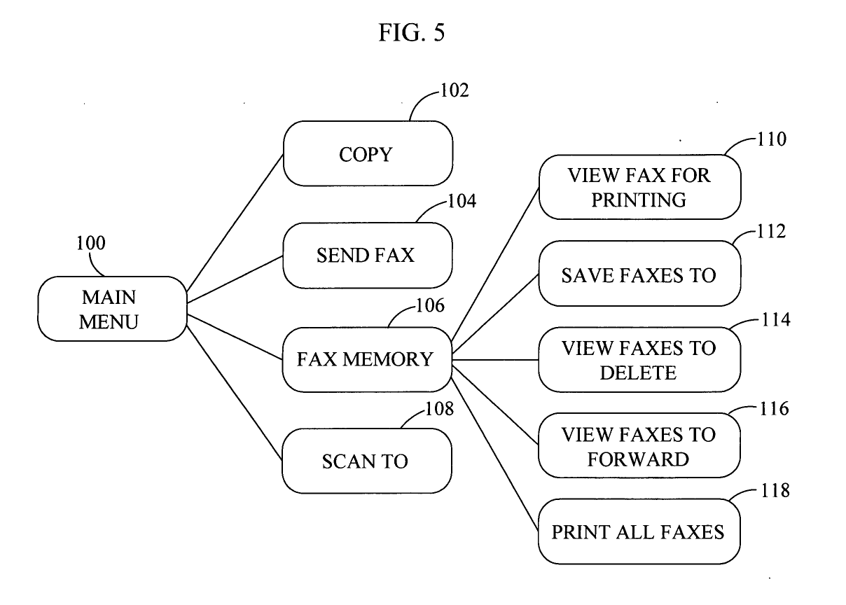

Referring now to FIG. 5, an illustrative menu tree flowchart is shown depicting the selectable menus for operating the multi-function peripheral device 10. From the main menu 100 a user may select a copy function 102 wherein data is scanned utilizing the scanner 30 (FIG. 4) and printed from the printer or image recording apparatus 20 (FIG. 4), a send fax function 104 wherein an original document is scanned utilizing the scanner 30 (FIG. 4) and faxed to another at least one fax machine via fax 40 (FIG. 4), or access fax memory 106 or finally perform a scan-to-application function 108 wherein a user scans at least one original document utilizing scanner 30 (FIG. 4) and saves the scanned data to a plurality of choices presented to the user (not shown in FIG. 5) such as to memory 82 or a removable memory device 84 or PC 90, or a network 96 (all of FIG. 4). If a user chooses to access fax memory 106 a plurality of choices are presented to the user. First, the user may view a fax (or portions thereof) for printing 110 or save a fax (or portions thereof) to 112, for example a PC 90, a network drive 96, or a removable memory device 84. The user may also view faxes (or portions thereof) to delete 114, view faxes (or portions thereof) to forward 116 wherein a user may choose to forward a fax to one or more fax machines chosen from a list (not shown in FIG. 5) presented to the user. Finally, the user may print all faxes in memory 118 by utilizing printer 20 (FIG. 4).

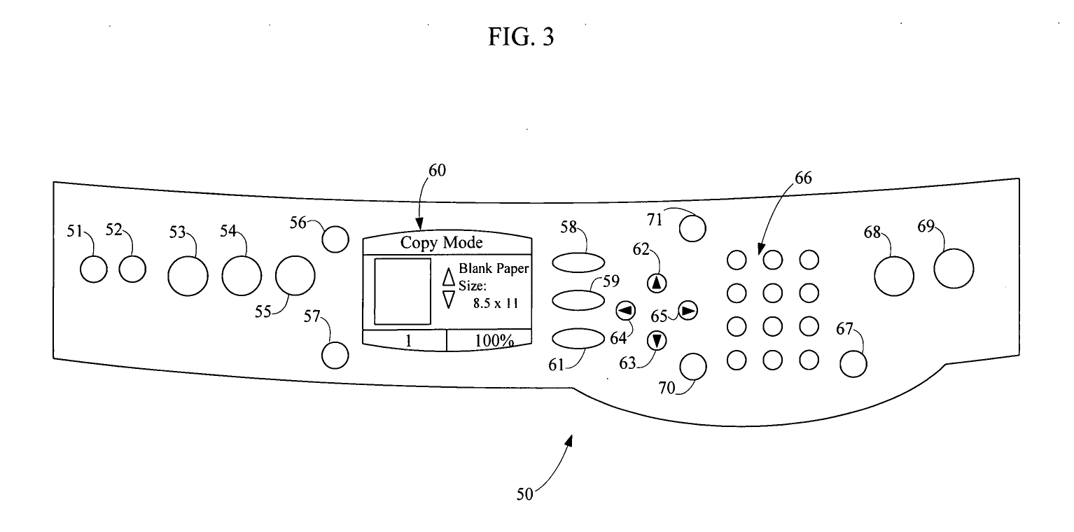

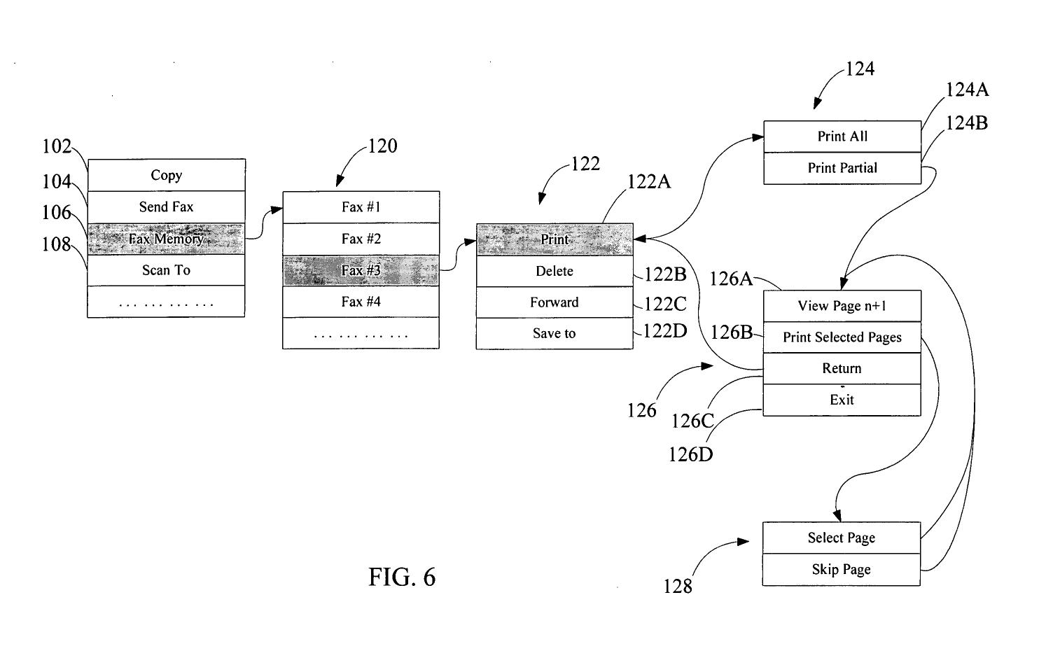

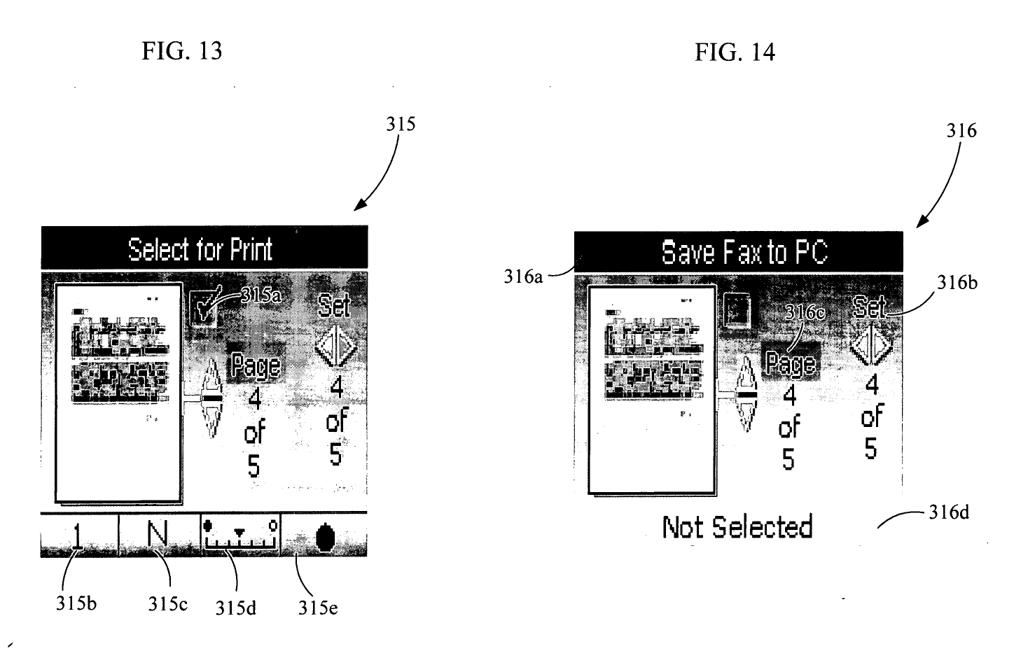

Referring now to FIG. 6, an illustrative function block diagram is shown depicting an alternative method of utilization of the present invention to allow editing of faxes prior to printing. Starting at the left hand side of the diagram a first set of sample selections is shown including a copy function 102, a send fax function 104, a fax memory function 106, and a scan-to-application function 108. The user may scroll through the selections with buttons 62,63. When the user selects (as illustrated by the use of the gray background in FIG. 6) the fax memory function 106, a second set of menu selections 120 are shown sequentially listing a number of the faxes as shown or alternatively displaying thumbnail images of faxes (see FIG. 13) stored in the onboard temporary memory 82. As the user scrolls up and down the menu 120 with the buttons 62, 63 of FIG. 3 and selects, for example, fax number three (3), a thumbnail image of the first page of the fax can be displayed along with a third menu 122 providing various choices which may be selected regarding the previously selected fax number in the second menu 120. As shown in the third menu 122, a user may select to print (all pages or selected pages) 122A, delete (all pages or selected pages) 122B, forward (all pages or selected pages) 122C, or save to (all or selected pages) 122D the fax selected in the second menu 120. If print selection 122A is made, a fourth menu 124 is shown allowing a user to choose from at least two options including print all 124A of the fax selected in the second menu or print partial 124B which allows a user to print selected pages of the selected fax, according to this example, the third fax. If a user selects to print partial from the fourth menu 124, a fifth menu 126 is shown allowing a user to view a specific page 126A, print a selected page or pages 126B, return 126C to the prior or third menu 122, or exit 126D the fax memory 106 mode. In the illustrative embodiment the user may select to view a specific page at 126A from the fifth menu 126 at which time the user may view a specific page and either select that page for printing or skip that page as shown in the sixth menu 128. After a user has selected all of the pages he or she desires to print, the user returns to the fifth menu 126 and selects to print the selected pages at which time the printer 20 begins printing the selected fax pages of the selected fax from the second menu 120. Thus, one skilled in the art will recognize that the present invention allows a user to selectively choose which faxes stored in memory 82 view, edit, and/or print all or selected pages from the specific fax.

According to either embodiment depicted in FIGS. 5 and 6, the device may utilize a caller ID function and time stamp function to identify the number from which the fax document originated and a time stamp designating when the fax document was received. It should be understood that the caller ID and time stamp functions may be displayed when the color graphics display 60 is utilized to view a fax image data in the memory 82.

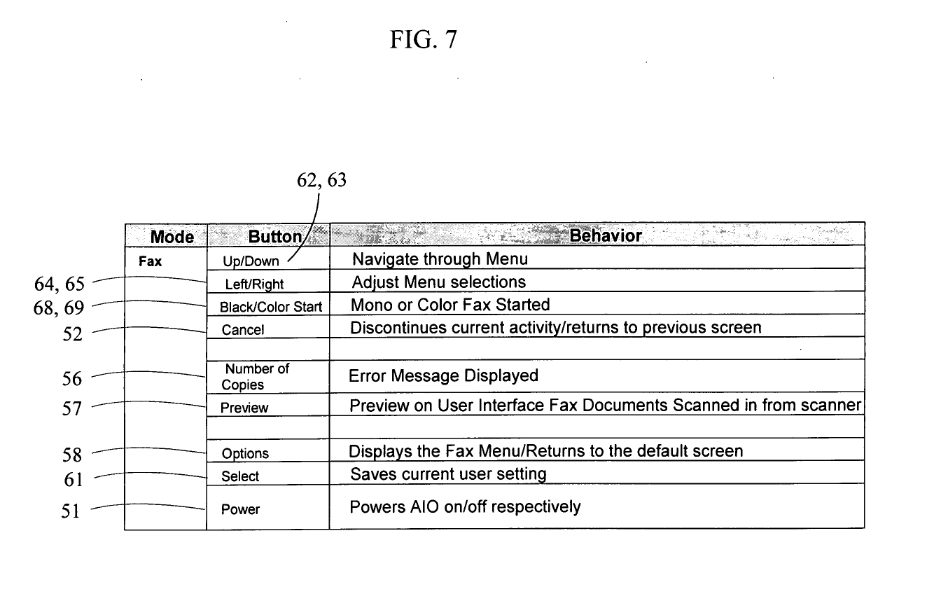

Referring now to FIG. 7, a chart is shown describing various functions of the buttons of control panel 50 when the multi-function peripheral device 10 is operating in a fax mode. For example, the up/down pair of buttons 62, 63 scroll through menu screens which will be shown and discussed hereinafter while the left/right arrow buttons 64, 65 adjust menu selections within the menus. The color/black buttons 68, 69 start color or monochromatic fax functions, respectively. The stop or cancel button 52 discontinues current activities and returns to a previous screen of the menu. The number of copies button 56, if pressed during fax mode, will result in an error message being displayed on the color graphics display 60. The preview button 57 in fax mode will scan an image of a document that the user wishes to send and that has been placed on the scanner platen and provides that image to the user interface display. The options button 58 functions as a toggle and displays either the fax options menu or returns the user from the options menu if already displayed. The power button 51 powers the device on or off. The select button 61 saves the current user settings that have been chosen by the user.

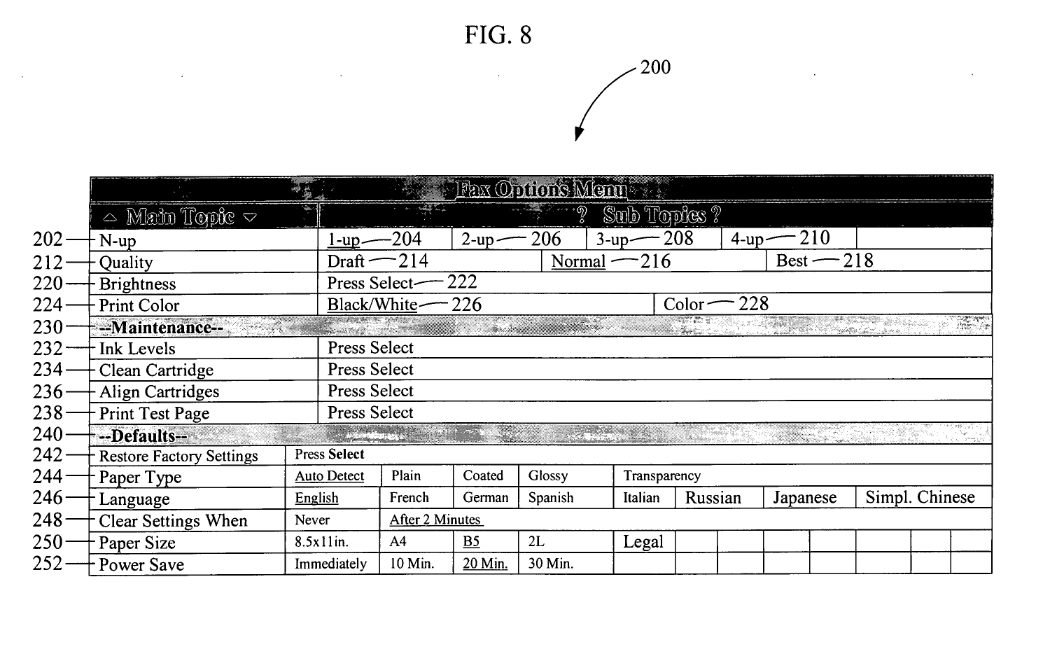

Referring now to FIG. 8, a chart depicting illustrative fax options under the fax options menu 200 is depicted and arranged in order to show how a user may move up and down through the menu selections along the left hand side of the chart using up/down arrow buttons 62, 63 and where a user may change selections utilizing left/right arrow buttons 64, 65. According to one embodiment, in order to access the fax options menu 200 depicted in the chart of FIG. 8, a user may press the fax button 55 on the control panel 50 followed by the options button 58. The chart 200 in FIG. 8 depicts all of the illustrative selections in a simple format. The first selection 202 under the main topic heading of the fax option menu chart 200 is labeled “N-UP” and provides the functionality of allowing a user to set a number of fax pages to be printed per each page printed by the printer 20. Accordingly, a user may use buttons 64, 65 to select the 1-UP selection 204 which prints a single fax page to each printed page, the 2-UP selection 206 which prints two fax pages per each printed page, the 3-UP selection 208 which prints three fax pages per each printed page, or the 4-UP selection 210 which prints four fax pages per each printed page from the multi-function peripheral device 10. In other words the user can select one-to-one, two-to-one, three-to-one, etc. page-per-page ratio for printing. Such a selection allows one form of editing of received faxes stored in memory 82 and various selections of “X-UP” may be provided by the fax options menu 200. However, one of ordinary skill in the art may understand that fax quality diminishes rather quickly because of lower scanning resolutions and therefore printing of more than four fax pages per printed page may result in a printed document which is substantially illegible. The next selection which may be obtained by using the down arrow button 63 under the main topic heading of the fax options menu 200 depicts a print quality selection 210. By utilizing left and right arrow button 64, 65, a user may change the print quality between a draft selection 214, a normal selection 216, and a best selection 218. The next selection under the main topic heading of the fax option menu is a brightness selection 220. This selection may be altered by pressing the select button 61 as represented by 222 in the fax options menu in order to change the brightness of the printed fax document. The next selection under the fax options menu 200 main topic column is a print color selection 224. By utilizing left and right arrow buttons 64, 65 a user may select between a black and white or monochromatic printing selection 226 and a color printing selection 228.

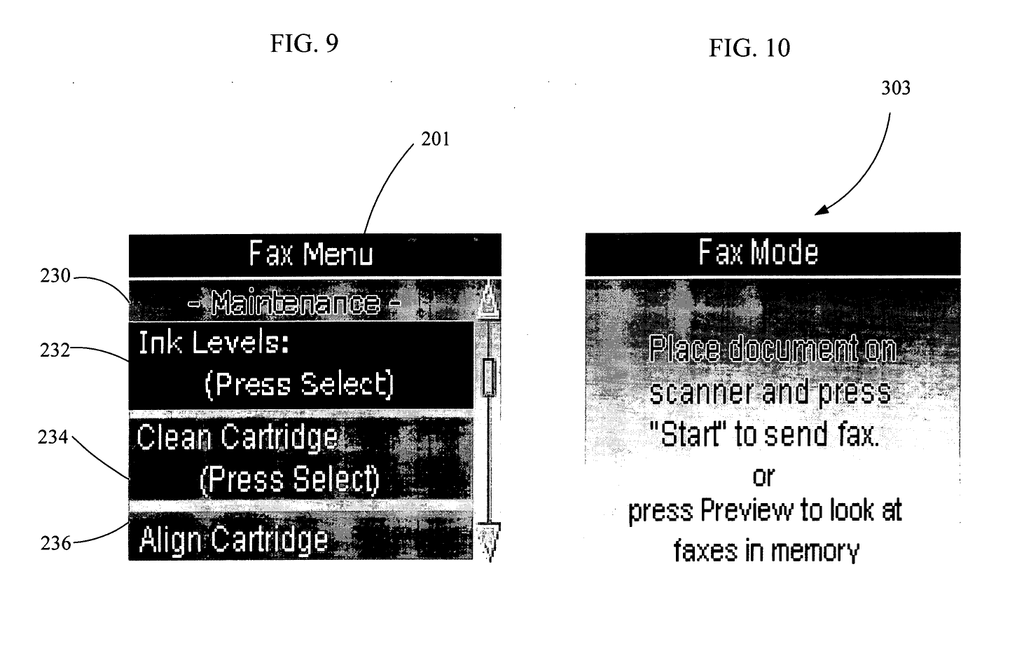

The next main topic heading in the fax options menu 200 is the maintenance menu heading 230 providing a plurality of maintenance settings and utilities. A user may again utilize the up/down arrow buttons 62, 63 to highlight a maintenance selection, the first of which is an ink levels selection 232 as shown in FIGS. 8 and 9 and which depicts an exemplary portion of the maintenance menu heading 230 as shown in the color graphics display 60. For example, once a selection is highlighted in the maintenance menu 230, the select button 61 is pressed and a visual display, such as a bar graph may be shown depicting the level of ink in the ink cartridges of the printer 20. The next selection within the maintenance menu heading 230 of the fax option menu 200 is a clean cartridge selection 234. The clean cartridge selection 234 is highlighted using the arrow buttons 62, 63 and is activated by pressing the select button 61 when highlighted on the menu of the color graphics display 60. The select button 61 causes the printer 20 to go through a cleaning mode wherein the printhead nozzles are cleaned to provide more favorable ink ejection onto print media. The next selection under the maintenance menu 230 of the fax options menu 200 is an align cartridges selection 236 which is highlighted using arrow buttons 62,63 and is activated by pressing the select button 61 while the selection 236 is highlighted in the menu of the color graphics display 60. The align cartridges selection provides improved print quality by aligning printheads to act as one. One additional selection under the maintenance menu heading 230 is a print test page selection 238 which is also selected by pressing the select button 61 of the control panel 50 while the selection 238 is highlighted on the color graphics display 60. This selection causes the printer 20 to print a test page and provides the user with a message stating that the printer is operating correctly or that the printer 20 may have an error.

The next heading of the fax option menu 200 is a defaults menu heading 240. Within the defaults heading 240 are a plurality of menu based selections including a restore factory settings selection 242 which may be highlighted and selected using the select button 61. Also within the defaults menu 240 is a paper type selection 244. Various paper types may be selected for use with the printer 20 by utilizing the left and right arrow buttons 64, 65 to select between an auto-detect setting wherein the printer detects the type of paper being utilized, a plain setting, a coated setting, a glossy setting, or a transparency setting. The next selection under the defaults menu heading 240 is a language selection 246. Within the language selection menu the left and right arrow buttons 64, 65 may be used to select between various languages including English, French, German, Spanish, Italian, Russian, Japanese, and simple Chinese. The next selection within the defaults menu 240 is a clear settings selection 248 which allows a user to clear settings at variable time intervals. The illustrative chart of the fax option menus in FIG. 8 provides two selections including a selection that the settings are never cleared and a selection clearing the settings after two minutes. Such selection may be toggled also utilizing the left and right arrow buttons 64, 65. The next selection within the fax options menu 200 and defaults menu selection 240 is a paper size selection 240 wherein the left and right arrow buttons 64, 65 may be utilized to choose between various paper sizes used within the printer 20. The exemplary choices depicted in the fax options menu 200 include 8½″×11″ (inch) paper, A4 paper, B5 paper, 2L paper, and legal size paper. The final selection under the defaults menu 240 of the fax options menu 200 is a power save selection 252 which can cause the multi-function peripheral device 10 to enter a power save mode after various time intervals of non-use. The selections under the power save selection 252 include immediately, ten minutes, twenty minutes, and thirty minutes. However, it is well within the scope of the present invention to alter these time intervals for starting the power save function of the multi-function peripheral device 10.

Referring now to FIGS. 9-20 various illustrative menu screens which may be displayed on the color graphics display 60 are shown to depict how a user may move through the menus within the fax mode of the multi-function peripheral device 10. When a color graphics display is used, various screen colors may be utilized to aid a user with navigation through the various menus as well as headings and sub-headings which orient a user within the menus. For example, as depicted in FIG. 9, a sample menu screen from the fax options menu 200 as shown on a color graphics display 60 is provided. The color graphics display includes a fax menu heading 201 in order to notify the user that the fax option mode is being shown on the color graphics display 60. Beneath the fax menu heading 201 is a maintenance sub-heading 230 through which a user may scroll utilizing the up and down arrow buttons 62, 63 in order to select between the ink level option 232, the clean cartridge option 234, the align cartridge option 236 and the print test page selection 238. Further scrolling utilizing the up and down arrow buttons 62, 63 will result in the print test page option 238 being viewable on the color graphics display 60.

FIG. 10 depicts a screen 303 which is displayed when the fax mode button 55 is pressed. This is an alternative method to the access the menu system provided through the illustrative menus of FIGS. 5 and 6. As shown in FIG. 10 at screen 303, the color graphics display 60 prompts the user to place a document on the scanner bed 30 or, alternatively, the automatic document feeder 34. The color graphics display 60 may also prompt the user to press the preview button 57 in order to review faxes stored in the onboard temporary memory 82. An additional alternative embodiment may provide a prompt for a user to input a target fax telephone number in order to provide a communication link between the multifunction peripheral device 10 and a target peripheral to which a fax document is directed, described further hereinafter.

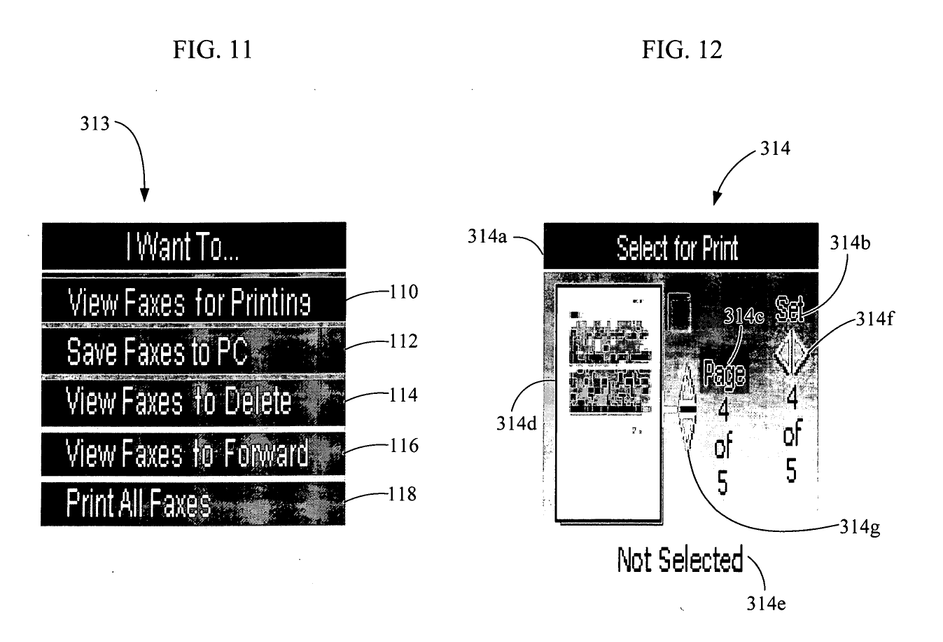

Referring now to FIG. 11, a screen 313 is depicted as shown on the color graphic display 60. The screen 313 corresponds to the selections which are shown in the menu tree of FIG. 5. The screen 313 provides selections shown in FIG. 5, for example, a selection is shown to view faxes for printing 110, save faxes to PC 112, view faxes to delete 114, view faxes to forward 116, and print all faxes 118. The following description will describe and show the various screens which are depicted in the color graphic display 60 after each of the selections shown in the screen 313 are made.

Referring now to FIGS. 3 and 12, upon a user choosing menu selection 110 (FIG. 5) from screen 313, screen 314 is displayed on the color graphics display 60. Screen 314 displays a faxed document stored in the onboard memory 82 which is selected for printing. There may be a plurality of faxed documents stored in the onboard memory 82 of the multi-function peripheral device 10 and therefore screen 314 provides a starting point for selection of any of the faxed documents stored in the memory to be printed. The screen 314 provides a heading 314a notifying the user that the selection will be printed. A user may utilize the left/right arrow buttons 64,65 to scroll through the various documents stored in the memory. These left/right arrow buttons are also shown as an icon 314f on the display as a visual reminder to the user as to which buttons to use for scrolling. Each of these stored faxed documents is referred to on the screen 314 as a set 314b. Each set may have a plurality of pages, thus the screen 314 displays the page number 314c as well as the total number of pages in the set 314b. As further depicted in the screen 314, the faxed document 314d is further depicted as a thumbnail image so that a user may review each page of each set in order to edit the faxed document prior to printing. The sub-headings 314b and 314c notify the user of the page number and set being depicted at 314d. A user may scroll through each page of a set utilizing the up/down arrow buttons 62, 63. These up/down arrow buttons are also shown as an icon 314g on the display as a visual reminder to the user as to which buttons to use for scrolling. Also shown at the bottom portion of the screen 314 is a status bar 314e which, according to the present embodiment, is not selected, meaning the faxed document shown on screen 314 is not selected for printing. However, as the faxed document pages are each reviewed, the pages may be selected for printing by pressing the select button 61. In this manner, a user may select the pages to be printed on a page-by-page basis thereby editing the document and inhibiting printing of unnecessary or unwanted pages.

On any screen where a fax page is shown in the color graphics display 60, the displayed page may be zoomed by pressing the zoom button 71 of FIG. 3. When pressed, the color graphics display 60 enters the zoom mode zooming the display, for example, three times (3×). As a result, the center 1/9 th of the original fax display is shown in the color graphics display 60. A user may scroll through the display 60 to view portions of the zoomed document by utilizing the arrow buttons 62,63,64,65. If the user presses the zoom button 71 again, the display is zoomed again three times (3×). If the user presses the zoom button 71 again, the color graphics display 60 exits the zoom mode. Alternatively, if a user presses the stop button 52 the zoom mode is exited.

As depicted in FIGS. 3 and 13, screen 315 is shown indicating that the fax document of screen 314 has been selected for printing. A check box 315a is shown next to the faxed document depicted as a thumbnail image on screen 315. As a result, the status bar 314d of FIG. 12 changes to depict four boxes at the bottom of screen 315. Referring to the left hand side of the status bar, the first box 315b shows the number of copies of the page shown on screen 315 to be printed. The current selection is one copy, however, this number may be changed utilizing the number of copies button 56 on the control panel 50 wherein each depression of button 56 and increments/decrements the count shown and results in an additional copy of the page shown being printed. Referring now to a box 315c, the letter N is shown and depicts the print quality of the page shown on screen 315—in this case Normal quality The print quality may be changed in the options menu by pressing the options button 58 and changing between draft (D) quality 214, normal (N) quality 216 and best (B) quality 218. The next box 315d depicts a print brightness setting and may also be adjusted by pressing the options buttons 58. Once the user enters the fax option menu 200, the brightness is changed by pressing the select button 61 a plurality of times to correspondingly change the brightness of the print setting and the indicator on display bar 315d will move accordingly. The final box depicted on screen 315 is in the lower right hand corner and represents a print color box 315e. The print color may be adjusted by pressing the options button 58 and accessing the fax options menu 200 wherein the print color may be changed for each page depending on the user's desire and the contents of the faxed document and the icon display 31 Se changes to either a color icon or a black and white icon depending upon the user selection. The user may choose between a black/white setting 226 or a color setting 228 as shown in the chart on FIG. 8.

Referring again to FIG. 11, when a user selects menu 112 in order to save a fax to a location, the user is directed to screen 316 as illustrated in FIG. 14. Screen 316 has an upper heading bar 316a to notify a user that the faxed document will be saved to a location, for example a PC 90 as illustrated. The screen 316 further comprises a set selection 316b which allows a user to choose between a plurality of documents representing a faxed document. The screen 316 further comprises a page selection 316c allowing a user to scroll between each page of a set in order to view the pages of the set on a page-by-page basis. The screen 316 further comprises a status bar 316d at the bottom of the screen notifying a user that the current page is not selected to be saved to PC 90. As previously indicated, a user may choose the zoom function by pressing button 71 of the control panel 50 shown in FIG. 3.

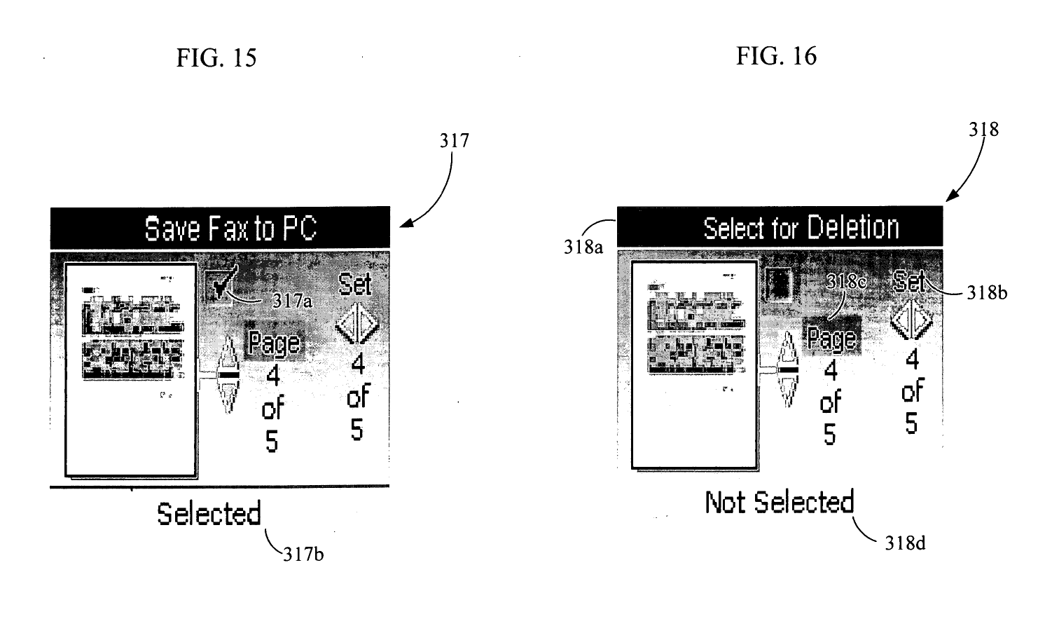

Referring now to FIG. 15 and still within the save fax to a location menu selection, a screen 317 is shown wherein a user has pressed button 61 (FIG. 3) in order to select the current page of the set to be saved. The screen 317 indicates such by the check mark 317a and by the indicia of the status bar 317b indicating the current page has been selected.

Referring now to FIG. 16, a screen 318 is depicted allowing a user to select a faxed document to be deleted corresponding to menu selection 114. Screen 318 depicts a heading 318a notifying a user that documents selected from this screen will be deleted. The screen 318 further comprises a set selection 318b and a page selection 318c which have been previously described. The screen 318 further comprises a status bar 318d at the bottom of the screen indicating whether a document page has been selected. As previously indicated, the zoom function may be used by depressing button 71 of the control panel 50 depicted in FIG. 3.

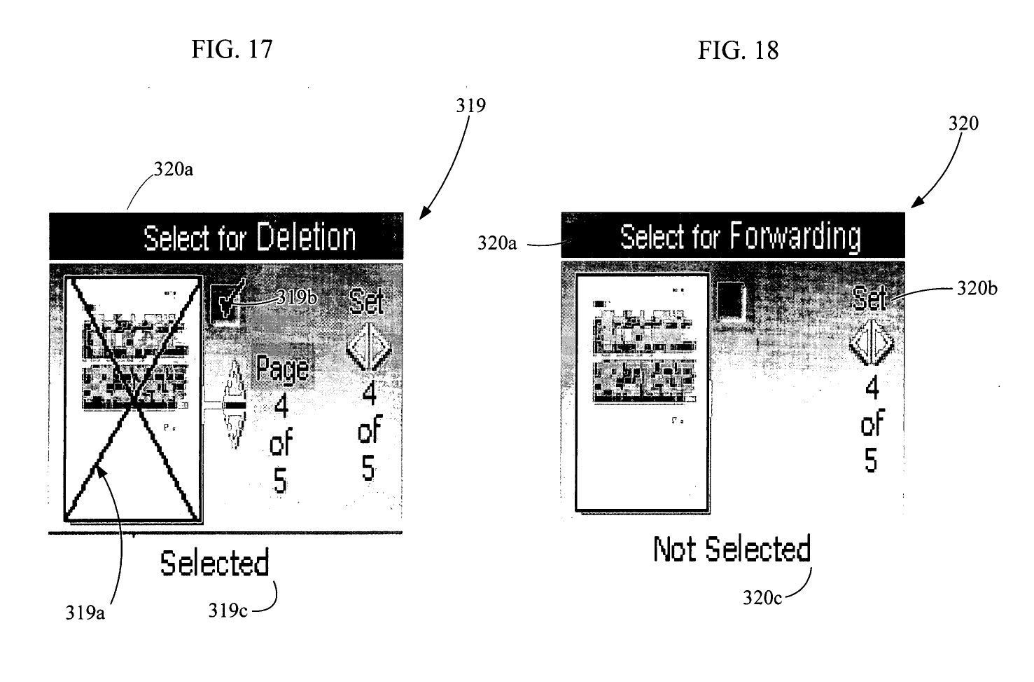

Referring now to FIG. 17, screen 319 is depicted and shows a page which is selected for deletion. The screen 319 further comprises a check box 319b indicating that the page has been selected for deletion by utilizing the select button 61. When the check box 319b is activated, the screen 319 depicts an image of the page 319a as being crossed out. The screen 319 further comprises a selected status in the status bar 319c at the bottom of the screen.

Referring now to FIG. 18, a screen 320 is shown to select a document set for forwarding. The forwarding screen 320 has a heading bar 320a notifying a user that selections made will be forwarded to another fax machine. The screen 320 depicts a set selection 320b since the inventors are assuming that a user will delete any pages that are not to be faxed previous to the forwarding function. The screen 320 further utilizes a status bar at the bottom of the screen 320 to notify user that the currently displayed set has not been selected.

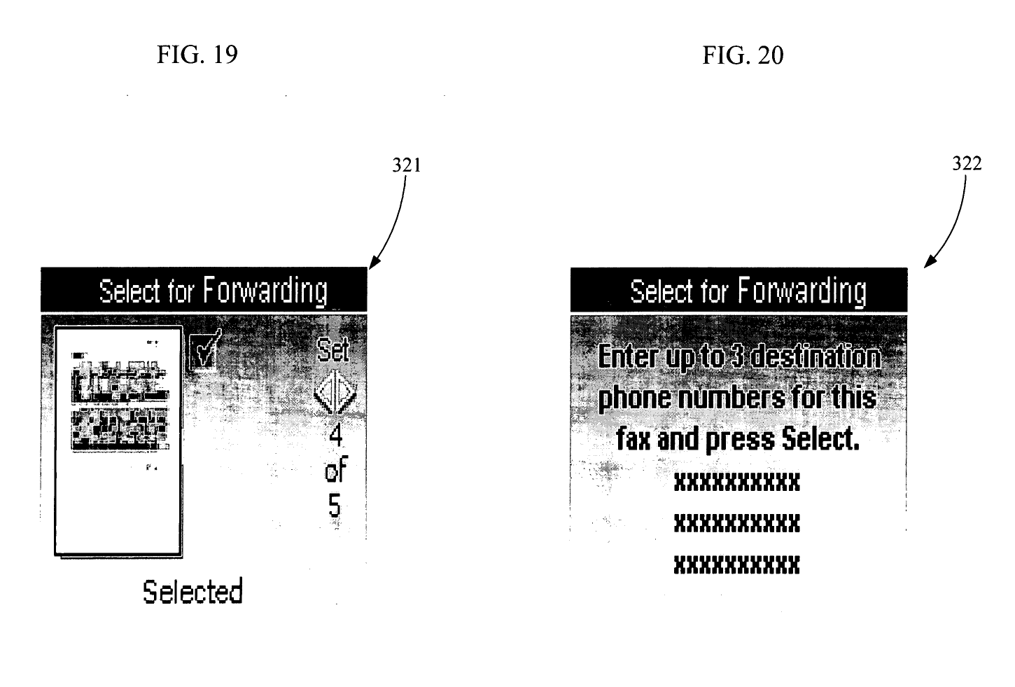

Referring now to FIG. 19, a screen 321 is now depicted that the set displayed in FIG. 18 has been selected by pressing the select button 61. Next the user is forwarded to a screen 322 shown in FIG. 20 where the user is prompted to enter up to three forwarding telephone numbers utilizing the alpha numeric keypad 66 following by pressing the select button 61 of FIG. 3.

It should be understood that various alternative menu trees or functions may be employed herein and are generally deemed to be within the scope of the present invention. However the fax mode is shown, and described, and illustrative of the present invention allowing preview, review, and edit of faxes stored in onboard memory via a color graphics or monochrome display.

1. An image recording apparatus with fax review/preview, comprising:
a multi-function peripheral device including a facsimile, a scanner, and a printer;
memory for storing fax image data;
a graphical display for reviewing and previewing said fax image data; and
at least one control for editing and selecting said fax image data.

2. The apparatus of claim 1 wherein said memory is solid state random access memory.

3. The apparatus of claim 1 wherein said memory is nonvolatile random access memory.

4. The apparatus of claim 1 wherein said fax image data may be stored on a disk storage device.

5. The apparatus of claim 1 wherein said graphical display is a color display.

6. The apparatus of claim 1 wherein said graphical display is a grayscale display.

7. The apparatus of claim 1 wherein said printer is an ink-jet printer.

8. The apparatus of claim 1 wherein said printer is a laser printer.

9. The apparatus of claim 1 wherein said fax has stand-alone capability.

10. The apparatus of claim 1 further comprising a host personal computer in electronic communication with said apparatus with fax review/preview.

11. The apparatus of claim 1 wherein said editing comprises a delete control for deletion of at least one portion of said fax image data.

12. The apparatus of claim 1 wherein said fax image data may be saved to a destination.

13. The apparatus of claim 12, wherein said editing comprises being done on a page-by-page basis of said fax image data.

14. The apparatus of claim 1 further comprising a time stamp function viewable on said graphical display.

15. The apparatus of claim 1 further comprising a caller identification function viewable on said graphical display.

16. A multifunction peripheral including fax preview/review function, comprising:
a multi-function peripheral comprising a stand-alone fax, a scanner, and a printer;
a color liquid crystal display interface;
a memory for storage of fax image data;
said color liquid crystal display interface providing a visual indication of said fax image data; and,
at least one control for editing and zooming said fax image data with said color liquid crystal display.

17. The peripheral of claim 16 wherein said editing comprises a deletion function allowing deletion of pages on a page-by-page basis of said fax image data.

18. The peripheral of claim 16, wherein said memory is nonvolatile random access memory.

19. The peripheral of claim 16, wherein said memory is solid state random access memory.

20. The peripheral of claim 16 further comprising disk storage for said fax image data.

21. A method of using an image recording apparatus with fax review-preview function, comprising:
receiving a fax document at said image recording apparatus;
storing said fax document in a memory in said image recording apparatus;
previewing said fax documents on a graphical display on said image recording apparatus;
selecting at least one page of said fax document based on said preview; and
selecting a disposition of said at least one selected page.

22. A multi-function peripheral, comprising:
a multi-function peripheral including a fax, scanner, and a printer;
a memory for storing received fax image data;
said fax image data in said memory being accessible for review and preview;
a graphics display for displaying said memory contents to review and preview said received data and said scanned data; and
said multi-function peripheral providing zoom capabilities of said fax image data on said graphics display.

23. The multi-function peripheral of claim 22 further comprising a liquid crystal display graphics display.

24. The multi-function peripheral of claim 23 further comprising a color liquid crystal display.

25. The multi-function peripheral of claim 22, wherein said multi-function peripheral provides editing capabilities for said fax image data.

26. A multi-function peripheral, comprising:
a multi-function peripheral including at least a facsimile portion;
a memory portion for retaining fax image data; and
a graphics display affixed to said multi-function peripheral wherein said graphics display depicts said fax image data of said memory portion and includes a user interface for zooming and editing said fax image data in said memory portion.

27. A multi-function peripheral, comprising:
a multi-function peripheral including a facsimile, a printer, and a scanner;
a memory portion operably communicating with said multi-function peripheral and storing received facsimiles;
a graphics display integral with said peripheral;
said graphics display depicting said received facsimiles stored in said memory portion; and
at least one interface for zooming and editing said stored facsimiles on said graphics display.

28. A printer in combination with a computer defining a fax preview-review apparatus, comprising:
a printer having a memory for storing fax image data;
said printer further comprising a graphical display for reviewing and previewing said fax image data;
at least one control for editing and selecting said fax image data; and
a computer having a dedicated facsimile line, and in communication with said printer.

29. The fax preview-review apparatus of claim 28 wherein said printer is an ink-jet printer.

30. The fax preview-review apparatus of claim 28 wherein said printer is a laser printer.
